(19) United States
(12) Patent Application Publication
(10) Pub. No.: US 2007/0067245 A1
(43) Pub. Date: Mar. 22, 2007

(54) Method and apparatus for content protection on hand held devices

(76) Inventor: Fathy Yassa, Soquel, CA (US)

Correspondence Address: Fathy Yassa, 4439 Esta Lane, Soquel, CA, 95073, US

(21) Appl. No.: 11/233,515

(22) Filed: Sep. 21, 2005

(51) Int. Cl. G06Q 99/00

(52) U.S. Cl. 705/59

(57) ABSTRACT

An exemplary method and apparatus for provided controlled access to content through a series of hardware and software rights management methods.

### CLAIM OF PRIORITY

This patent application claims priority from provisional patent application entitled METHOD AND APPARARUS FOR CONTENT RIGHTS MANAGEMENT, filed on Sep. 22, 2004, US Mail Label No.: EO 905 199 185 US.

### BACKGROUND OF THE INVENTION

During the analog age, owners of copyrighted audio and visual content did not overly concern themselves about the unauthorized duplication of content by the average consumer. The nature of the analog medium prohibited most consumers from making a significant number of unauthorized duplicates because an analog duplicate is always inferior to its source. Thus within a few generations, the duplicates are useless. Further, as most analog medium required physical contact with the playback device, the original source degraded each time a copy was made. Thus content owners generally did not expend significant resources in applying the few existing copy protection schemes to most analog content.

The advent of the digital age combined with cheap mass storage devices enabled the average user to make unlimited, near perfect duplicates from a given digital content source such as a CD or DVD. Thus, for the first time, owners and distributors of content had to contend with the average consumer having the power to mass-produce copyrighted content.

The proliferation of relatively inexpensive high speed telecommunications gave the average consumer the additional ability to mass distribute copyrighted content. Thus today, many consumers choose to download content, especially, music, via the public internet, in lieu of purchasing the content.

Owners of copyrighted content have responded utilizing a variety of technical means. They have placing electronic locks within the content which ostensibly prevents the unauthorized copying or distributing of copyrighted content. One such lock is a digital watermark. Today this is known as digital rights management.

Digital rights management endeavors to return control of the distribution of copyrighted content to the copyright holder, by making it difficult, if not impossible, to save, duplicate, or transmit, the restricted content. These methods have met with varying levels of success. One technique involves the user connecting to the content owner's internet server to periodically validate playback permission for content. Another method includes encoded expiration dates within the content.

Both methods have severe limitations. The former method requires an internet connection which effectively prevents the user of the content in a non-PC environment, such as a car stereo. The latter method has proven exceptionally easy to circumvent.

Today, the standard in digital rights management is the public/private key combination. In cryptography, a public key is a value provided by some designated authority as an encryption key that, combined with a private key derived from the public key, can be used to effectively encrypt messages and digital signatures. The use of combined public and private keys is known as asymmetric cryptography. A system for using public keys is called a public key infrastructure.

Hand held devices present special challenges for digital rights management. They often do not have internet connections for validating playback permission. Additionally, many modern devices have removable memory card which may permit the distribution of content without the content owner's permission.

Thus many digital rights management system include a method of validating content which is embedded within the content itself. These systems must validate both the length of time the content is authorized, but also who is authorized to view the content, and on what machine or machines, the content may be viewed.

### DETAILED DESCRIPTION OF THE EMBODIMENTS

This invention herein disclosed an exemplary method for digital content rights management on a hand held device. Instead of using the public key system, the keys are derived from the one or more characteristics of a hand held devices including, but not limited to the SIM card, the MAC address, and the serial number. These keys may be used in conjunction with each other, or separately, along with an private algorithm, to create an encoding scheme to encrypt the content before storing and lock the content in memory (onboard or removable memory device) so that it cannot be accessed without the key.

Digital content always contains header information which is generally separate and distinct from the content data. This header information may include such information as content type, name, size, etc. Within this header, encryption information can be encoded. Encoding ranges from a simple look-up table to validate playback authorization to encoding the content based upon the various encryption schemes. In the latter case, the content utilizes a key system where the key determines the method of encryption and decryption.

In one embodiment of the invention the origination server reads the SIM card on the destination device and encodes the content based upon the unique identifiers of the SIM card. This unique identifier prevents the content from being used on any other hand held device if the SIM card is a permanent part of the device. If the SIM card is removable, then the invention permits the playback of the content on only one device, to wit: the device currently hosting said SIM card.

In another embodiment of the invention, the origination server reads the serial number of the device and encodes the content based upon the unique serial number of the hand held device. This also prevents the content from being used on any other hand held device.

In yet another embodiment of the invention, the origination server reads the MAC or media access control, address. Like the unique SIM identifier, the unique number allows the content to be played only on the destination device.

In a further embodiment of the invention, the origination server encodes the content based upon the user supplied information such as username, password, etc. This serves to tie the content to the user, rather than a specific device.

In another embodiment of the invention, the invention combines 1 or more protection schemes to create greater security and user options.

In yet another embodiment, the handheld device receives the information encoded and decodes it using the keys created by the invention. Alternatively, the handheld device receives the information in an unencrypted form and encrypts it upon storage.

We claim:

1. A multi-identification contents access management system composed of a digital rights management system, a software lock, and a hardware lock, all working together to authenticate the user and permissive uses of content.
